(19) United States
(12) Patent Application Publication
(10) Pub. No.: US 2023/0307751 A1
(43) Pub. Date: Sep. 28, 2023

(54) STORAGE CASE OF ELECTRODE ROLL

(71) Applicant: HONDA MOTOR CO., LTD., Tokyo (JP)

(72) Inventors: Kenta KASANO, Saitama (JP); Michimasa TABUCHI, Saitama (JP)

(73) Assignee: HONDA MOTOR CO., LTD., Tokyo (JP)

(21) Appl. No.: 18/110,185

(22) Filed: Feb. 15, 2023

(30) Foreign Application Priority Data
Mar. 25, 2022 (JP) 2022-050769

(51) Int. Cl. H01M 50/186; H01M 50/107; H01M 50/538; H01M 10/0562

(52) U.S. Cl. CPC H01M 50/186; H01M 50/107; H01M 50/538; H01M 10/0562; H01M 2300/0068

(57) ABSTRACT

A storage case of an electrode roll of a secondary battery having a hollow core and an electrode body wound around the core includes a case that covers the electrode roll. The storage case has a structure in which a space in which the electrode body is housed is sealed by the case and protrusions protruding in an axial direction of the core from end surfaces of the electrode body at both ends of the core.

### CROSS-REFERENCE TO RELATED APPLICATIONS

This application is based on and claims priority under 35 USC 119 from Japanese Patent Application No. 2022-050769 filed on Mar. 25, 2022, the contents of which are incorporated herein by reference.

### TECHNICAL FIELD

The present disclosure relates to a storage case of an electrode roll.

### BACKGROUND

In recent years, researches and development on secondary batteries that contribute to efficiency of energy have been carried out to ensure access to affordable, reliable, sustainable, and modem energy for more people.

As a technique of manufacturing an electrode related to a secondary battery, Japanese Patent Application Laid-Open Publication No. 2021-34227 discloses a winding device for winding a base material for forming an electrode, and an unwinding device for unwinding the base material.

Japanese Patent Application Laid-Open Publication No. 2019-160609 discloses a roll film deposition apparatus for manufacturing an electrode sheet used in a sulfide all-solid-state battery.

In a battery manufacturing line, an electrode roll having an electrode body wound by a winding device is set in an unwinding device. When humidity of a space in which the electrode roll is present is not kept low, for example, hydrogen sulfide is generated from the electrode body including a sulfide-based electrolyte.

For this reason, setting the electrode roll in the unwinding device is generally performed under a large-scale facility to maintain the humidity.

The present disclosure proposes a storage case of an electrode roll capable of housing the electrode roll in a state where appropriate humidity is maintained. Further, the present disclosure contributes to efficiency of energy.

### SUMMARY

An aspect of the present disclosure relates to a storage case of an electrode roll of a secondary battery having a hollow core and an electrode body wound around the core includes a case that covers the electrode roll. The storage case has a structure in which a space in which the electrode body is housed is sealed by the case and protrusions protruding in an axial direction of the core from end surfaces of the electrode body at both ends of the core.

According to the present disclosure, an electrode roll can be housed in a state where appropriate humidity is maintained.

### BRIEF DESCRIPTION OF DRAWINGS

Exemplary embodiment(s) of the present invention will be described in detail based on the following figures, wherein:

FIG. 1 illustrates a storage case 1:

FIG. 2 illustrates a core 21 of an electrode roll 2;

FIG. 3 illustrates the electrode roll 2 in which an electrode body 22 is wound around the core 21;

FIG. 4A illustrates the electrode roll 2 placed on a first case 11:

FIG. 4B is a partially enlarged view of FIG. 4A:

FIG. 4C is a top view illustrating the electrode roll 2 placed on the first case 11;

FIG. 5A illustrates a sealing portion 3:

FIG. 5B illustrates a first sealing portion 31:

FIG. 6 illustrates the storage case 1 sealed by the sealing portion 3;

FIG. 7 is a view for explaining a material used for a part of the sealing portion 3:

FIG. 8A illustrates the storage case 1 disposed in an electrode roll housing chamber 4 with a front door opened;

FIG. 8B illustrates the storage case 1 disposed in the electrode roll housing chamber 4 with the front door closed;

FIG. 8C illustrates a state where a second case 12 of the storage case 1 is opened and the electrode roll 2 is exposed;

FIG. 8D illustrates a state where unwinding of the electrode body 22 is started by rotation of an unwinding shaft;

FIG. 9A illustrates a state where an unwinding shaft 5 is inserted into an electrode roll 2 covered with a first case 11 and a second case 12 in a storage case 1 of a modification;

FIG. 9B illustrates a state where the second case 12 is detached and the electrode roll 2 is exposed; and

FIG. 9C is a partially enlarged view of FIG. 9A.

### DESCRIPTION OF EMBODIMENTS

Hereinafter, an embodiment of the present disclosure will be described with reference to the accompanying drawings.

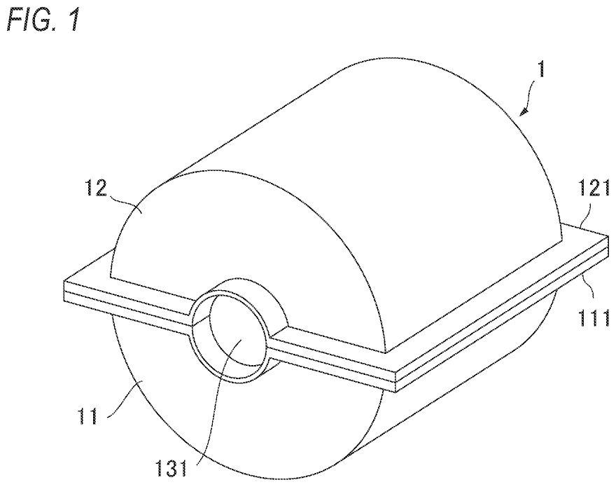

FIG. 1 illustrates a storage case 1 according to the present embodiment. The storage case 1 is a case for storing an electrode roll 2 (see FIG. 3) of a secondary battery such as an all-solid-state battery, and is made of metal or resin, for example. An electrode body 22 coated with a slurry containing a sulfide-based solid electrolyte or the like is wound around a core 21 by a winding device or the like to form the electrode roll 2, and the electrode roll 2 is stored in the storage case 1, for example, until unwinding by an unwinding device is started. Although details will be described later, the storage case 1 is also used in the process of unwinding the electrode body 22.

The storage case 1 includes a first case 11 and a second case 12. The first case 11 has a structure in which a flat surface and a curved surface are connected to each other so as to form a semi-cylindrical space therein, and has a first flange portion 111 for securing a contact region with the second case 12. The second case 12 has a structure in which a flat surface and a curved surface are connected to each other so as to form a semi-cylindrical space therein, and has a second flange portion 121 for securing a contact region with the first case 11.

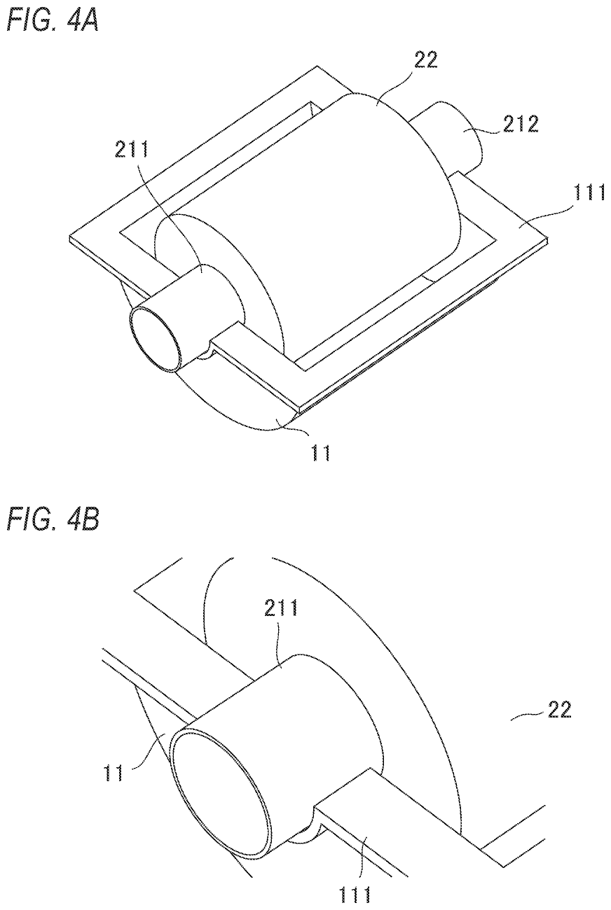

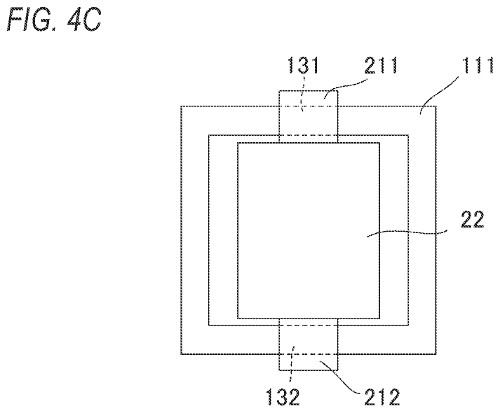

When the first case 11 and the second case 12 are overlapped with each other so that the first flange portion 111 and the second flange portion 121 are in contact with each other, a cylindrical space is formed inside the storage case 1. The first flange portion 111 and the second flange portion 121 each have a semicircular arc shape at a portion from which an unwinding shaft is inserted so that the unwinding shaft can be inserted in a state where the electrode roll 2 is stored in the storage case 1. Openings 131 and 132 are formed by a semicircular arc portion of the first flange portion 111 and a semicircular arc portion of the second flange portion 121 (see FIG. 4C). A center of the core 21 coincides with a center of a circle formed by the semicircular arc portion of the first flange portion 11 and the semicircular arc portion of the second flange portion 121.

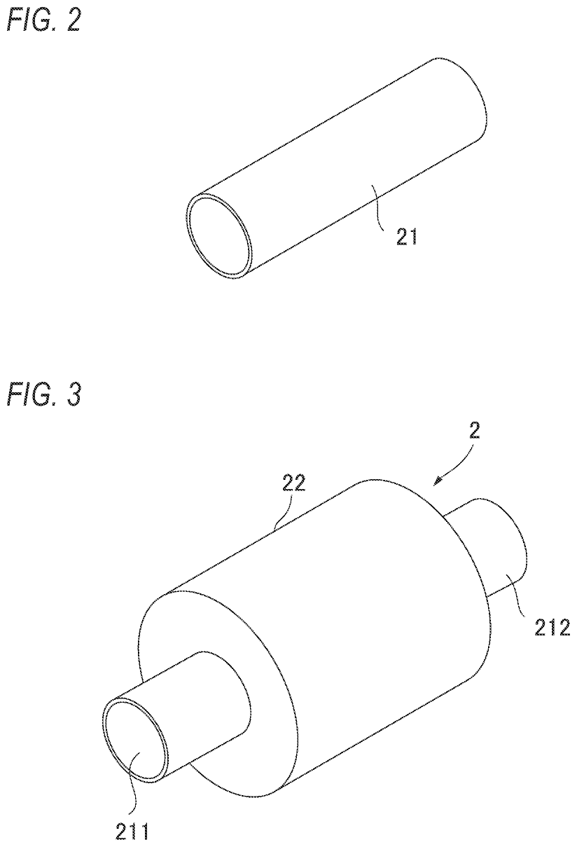

FIG. 2 illustrates the core 21 of the electrode roll 2. The core 21 is made of, for example, metal or resin, and has a hollow structure. A winding shaft is inserted into and engaged with the core 21, and the core 21 is rotated by a motor, whereby the electrode body 22 can be wound. Similarly, the unwinding shaft is inserted into and engaged with the core 21, and the core 21 is rotated by a motor, whereby the electrode body 22 can be unwound.

FIG. 3 illustrates the electrode roll 2 in which the electrode body 22 is wound around the core 21. Since a length of the core 21 in an axial direction is larger than a width (a length in the axial direction) of the wound electrode body 22, protrusions 211 and 212 protruding from end surfaces of the electrode body 22 are formed at both ends of the core 21 (see also FIG. 4C). The length of the core 21 is preferably larger than a length in the axial direction of the first case 11 and the second case 12 that are overlapped with each other.

FIG. 4A illustrates the electrode roll 2 placed on the first case 11, FIG. 4B is a partially enlarged view of FIG. 4A, and FIG. 4C is a top view illustrating the electrode roll 2 placed on the first case 11.

The protrusions 211 and 212 of the core 21 are placed on two semicircular arc portions of the first case 11 arranged to face each other. In a state where the protrusions 211 and 212 are placed on the two semicircular arc portions of the first case 11, the electrode body 22 is not in contact with the first case 11, and there is a space between the electrode body 22 and the first case 11. Shapes and sizes of the protrusions 211 and 212 and the two semicircular arc portions in contact with the protrusions 211 and 212 are determined such that no gap is formed between the protrusions 211 and 212 and the semicircular arc portions. The protrusions 211 and 212 may be engaged with the first case 11.

The electrode roll 2 is housed in the storage case 1 by overlapping the second case 12 with the first case 11 in the state illustrated in FIGS. 4A to 4C. Shapes of two semicircular arc portions of the second case 12 are also determined such that no gap is formed between the semicircular arc portions and the protrusions 211 and 212. In a state where the electrode roll 2 is housed in the storage case 1, the electrode body 22 is not in contact with the storage case 1, and there is a space between the electrode body 22 and the storage case 1. Moisture may be prevented from entering by setting a pressure in the space to a positive pressure higher than the atmospheric pressure using a pump or the like. The first case 11 and the second case 12 may be fixed by, for example, fasteners.

Since the electrode roll 2 is housed in the storage case 1 as described above, the space between the electrode body 22 and the storage case 1 can be sealed. Therefore, by filling the space with gas or the like, the electrode roll can be stored in a state where the humidity is kept low, and harmful substances such as hydrogen sulfide can be prevented from being generated from the electrode body 22.

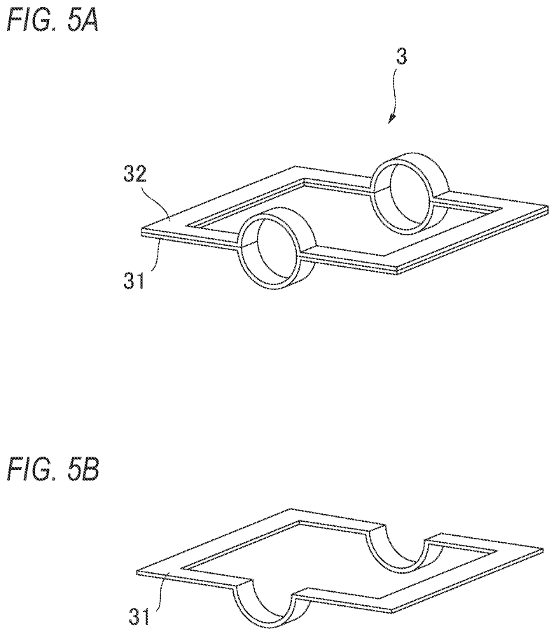

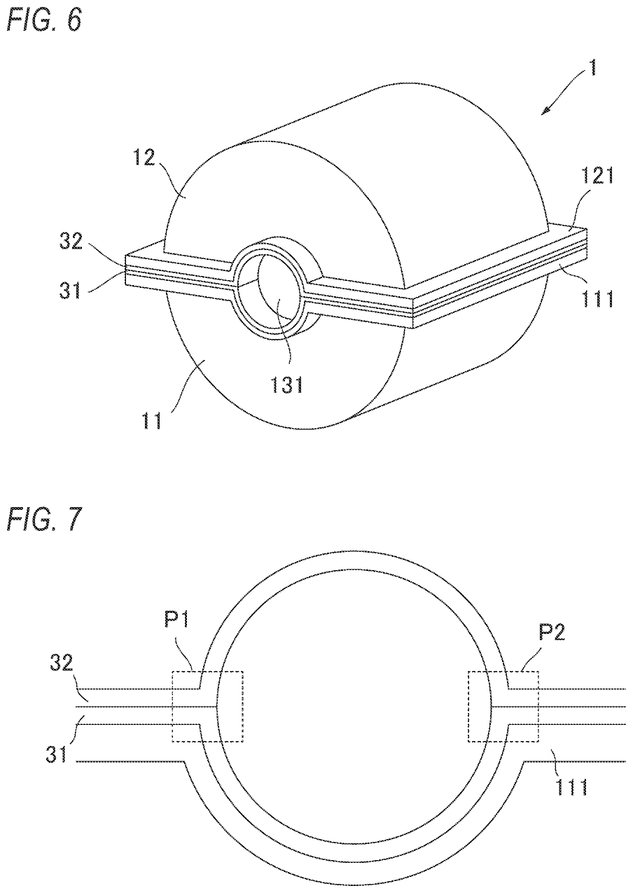

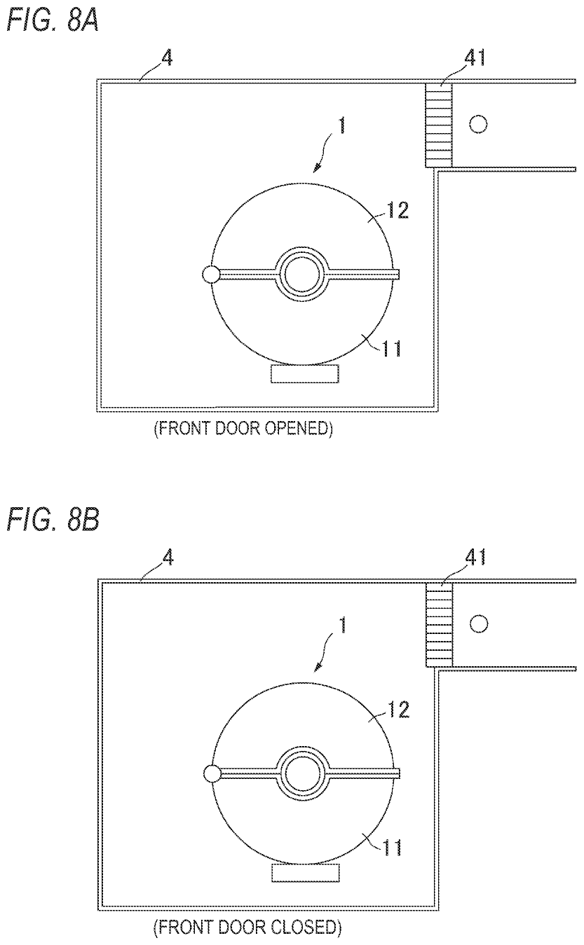

By providing a sealing portion 3 between the first flange portion 111 and the second flange portion 121, sealing performance of the storage case 1 can be enhanced. Hereinafter, the sealing portion 3 will be described with reference to FIGS. 5A to 6.

FIG. 5A illustrates the sealing portion 3. The sealing portion 3 includes a first sealing portion 31 and a second sealing portion 32. FIG. 5B illustrates the first sealing portion 31. The first sealing portion 31 is attached to the first flange portion 111 such that no gap is formed between the first sealing portion 31 and the first flange portion 1. The second sealing portion 32 is attached to the second flange portion 121 such that no gap is formed between the second sealing portion 32 and the second flange portion 121. In addition, the first sealing portion 31 and the second sealing portion 32 each have a semicircular arc portion such that no gap is formed between the first sealing portion 31 and the protrusion 211 and between the second sealing portion 32 and the protrusion 212. The first sealing portion 31 and the second sealing portion 32 are made of, for example, rubber. The center of the core 21 coincides with a center of a circle formed by the semicircular arc portion of the first sealing portion 31 and the semicircular arc portion of the second sealing portion 32.

FIG. 6 illustrates the storage case 1 sealed by the sealing portion 3. In the openings 131 and 132 secured by the first sealing portion 31 and the second sealing portion 32, the protrusions 211 and 212 are appressed against the semicircular arc portion of the first flange portion 111 and the semicircular arc portion of the second flange portion 121 via the first sealing portion 31 and the second sealing portion 32. In this way, by providing the sealing portion 3 between the first flange portion 111 and the second flange portion 121, it is possible to enhance the sealing performance of the storage case 1.

From ranges P1 and P2 (that is, contact portions between the first sealing portion 31 and the second sealing portion 32 that are in contact with the protrusions 211 and 212) surrounded by broken lines in FIG. 7, the moisture is more likely to enter the storage case 1 than other portions of the sealing portion 3. Therefore, the sealing performance may be further enhanced by using a rubber material or the like softer than other portions of the sealing portion 3. Sizes of ranges P1 and P2 may be predetermined based on a distance from a contact surface between the first sealing portion 31 and the second 32 and a distance from a surface of the protrusion 211 or protrusion 212. In other words, the first sealing portion 31 and the second sealing portion 32 included in ranges P1 and P2 may be within a first predetermined distance from the contact surface and a second predetermined distance from the surface of the protrusion 211 or protrusion 212.

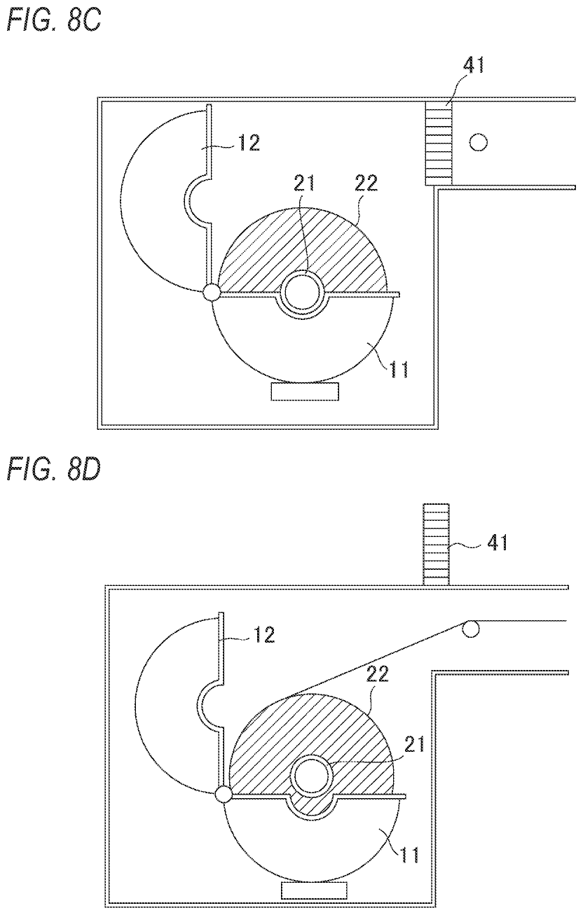

A flow from setting the electrode roll 2 in the unwinding device (a conveying device) to starting unwinding will be described with reference to FIGS. 8A to 8D.

In a stage of FIG. 8A, the electrode roll 2 is housed in the storage case 1, and the storage case 1 is placed in an electrode roll housing chamber 4. An unwinding shaft 5 (not shown) is set on the core 21 of the electrode roll 2. Although the space inside the storage case 1 is sealed, humidity inside the electrode roll housing chamber 4 is the same as humidity outside the electrode roll housing chamber 4 because a front door of the electrode roll housing chamber 4 is open.

At a stage of FIG. 8B, the front door is closed, and no air flows between the inside of the electrode roll housing chamber 4 and the outside of the electrode roll housing chamber 4. The inside of the electrode roll housing chamber 4 is filled with gas or the like, and appropriate humidity is maintained.

In a stage of FIG. 8C, the second case 12 of the storage case 1 is manually opened with a glove or the like from the outside of the electrode roll housing chamber 4. In this example, the first case 11 and the second case 12 are coupled by a hinge, and the second case 12 is configured to rotate relative to the first case 11 to be opened and closed. Since no air enters the inside of the electrode roll housing chamber 4 from the outside of the electrode roll housing chamber 4, the humidity inside the electrode roll housing chamber 4 is maintained in an appropriate state.

At a stage of FIG. 8D, the first case 11 is detached downward from the core 21. A pass line shutter 41 of the electrode roll housing chamber 4 is opened, and the electrode body 22 is unwound onto a conveyance path by rotating the unwinding shaft.

If the electrode roll 2 is unwound according to the above flow, the electrode body 22 is not exposed to the air outside the electrode roll housing chamber 4 when the storage case 1 is opened, and thus harmful substances such as hydrogen sulfide can be prevented from being generated from the electrode body 22.

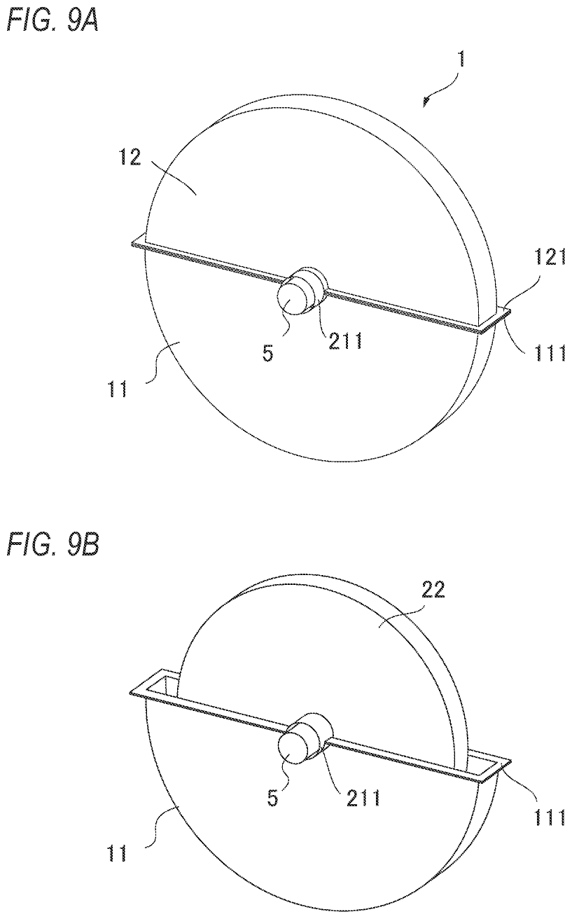

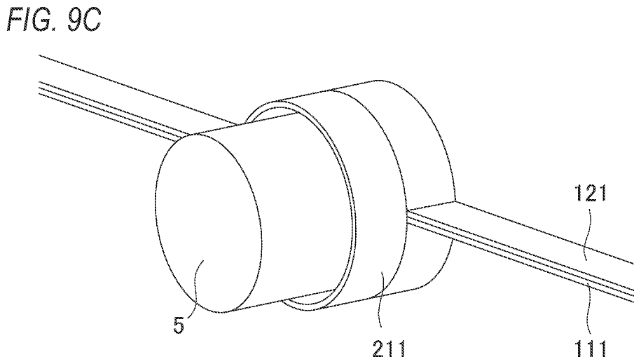

The shape of the electrode body 22 is not limited to the cylindrical shape as shown in FIG. 3. FIGS. 9A to 9C show a storage case 1 of a modification for storing a disk-shaped (that is, a length of a cylinder is sufficiently smaller than a diameter of a circle) electrode body 22. FIG. 9A illustrates a state where an unwinding shaft 5 is inserted into an electrode roll 2 covered with a first case 11 and a second case 12 in the storage case 1 of the modification. FIG. 9B illustrates a state where the second case 12 is detached and the electrode roll 2 is exposed, and FIG. 9C is a partially enlarged view of FIG. 9A.

As shown in FIGS. 9A and 9B, when the shape of the electrode roll is a disk shape, the shape of the storage case 1 is also disk-shaped preferably.

In the above-described example, the shape of the storage case 1 is circular as viewed from the axial direction of the core 21, but may be rectangular or square.

Although various embodiments have been described above with reference to the drawings, it is needless to say that the present invention is not limited to such an example. It is apparent to those skilled in the art that various changes and modifications can be conceived within the scope of the claims, and it is also understood that such changes and modifications naturally belong to the technical scope of the present invention. In addition, constituent elements in the above embodiments may be freely combined without departing from the spirit of the invention.

The present specification describes at least the following matters. Although corresponding components or the like in the above-described embodiments are shown in parentheses, the present invention is not limited thereto.

(1) A storage case (storage case 1) of an electrode roll (electrode roll 2) of a secondary battery having a hollow core (core 21) and an electrode body (electrode body 22) wound around the core, the storage case including:
a case (first case 11 and second case 12) that covers the electrode roll, in which
the storage case has a structure in which a space in which the electrode body is housed is sealed by the case and protrusions (211, 212) protruding in an axial direction of the core from end surfaces of the electrode body at both ends of the core.

According to (1), the electrode body can be stored so as not to be exposed to the outside air. That is, with the storage case, the electrode roll can be housed in a state where appropriate humidity is maintained.

(2) The storage case of an electrode roll according to (1), in which
the electrode body contains a sulfide-based solid electrolyte.

According to (2), hydrogen sulfide can be prevented from being generated from the electrode body.

(3) The storage case of an electrode roll according to (1) or (2), in which
the space in which the electrode body is housed has a positive pressure in a state where the space is sealed by the case and the protrusions.

According to (3), it is possible to effectively prevent the outside air from entering the inside of the storage case.

(4) The storage case of an electrode roll according to any one of (1) to (3), in which
the case includes a first case (first case 11) that covers one side of the electrode roll and a second case (second case 12) that covers the other side of the electrode roll, and
the first case and the second case overlap each other with a sealing portion (sealing portion 3) sandwiched therebetween.

According to (4), the sealing performance of the storage case can be enhanced.

(5) The storage case of an electrode roll according to (4), in which
the sealing portion includes a first sealing portion (first sealing portion 31) provided in the first case and a second sealing portion (second sealing portion 32) provided in the second case and in contact with the first sealing portion, and
a portion where the first sealing portion and the second sealing portion are in contact with each other and which is in contact with the protrusion portion is softer than other portions of the sealing portion.

The outside air is likely to enter from the contact portion between the first sealing portion and the second sealing portion that is in contact with the protrusion. According to (5), it is possible to prevent the outside air from entering from the portion.

1. A storage case of an electrode roll of a secondary battery having a hollow core and an electrode body wound around the core, the storage case comprising:
a case that covers the electrode roll, wherein
the storage case has a structure in which a space in which the electrode body is housed is sealed by the case and protrusions protruding in an axial direction of the core from end surfaces of the electrode body at both ends of the core.

2. The storage case of an electrode roll according to 1, wherein
the electrode body comprises a sulfide-based solid electrolyte.

3. The storage case of an electrode roll according to claim 1, wherein
the space in which the electrode body is housed has a positive pressure in a state where the space is sealed by the case and the protrusions.

4. The storage case of an electrode roll according to claim 1, wherein
the case includes a first case that covers one side of the electrode roll and a second case that covers the other side of the electrode roll, and
the first case and the second case overlap each other with a sealing portion sandwiched therebetween.

5. The storage case of an electrode roll according to claim 4, wherein
the sealing portion includes a first sealing portion provided in the first case and a second sealing portion provided in the second case and in contact with the first sealing portion, and
a portion where the first sealing portion and the second sealing portion are in contact with each other and which is in contact with the protrusion portion is softer than other portions of the sealing portion.
